(19) United States
(12) Patent Application Publication
(10) Pub. No.: US 2016/0314377 A1
(43) Pub. Date: Oct. 27, 2016

(54) Using Similarity for Grouping Fonts and Individuals for Recommendations

(71) Applicant: Monotype Imaging Inc., Woburn, MA (US)

(72) Inventors: Joseph Vieira, Maynard, MA (US); Seah Chickering-Burchesky, Woburn, MA (US)

(21) Appl. No.: 14/694,494

(22) Filed: Apr. 23, 2015

(51) Int. Cl. G06K 9/62; G06K 9/52; G06F 17/21; G06Q 30/06; G06F 17/30; G06K 9/18; G06T 7/60

(52) U.S. Cl. CPC G06K 9/6267; G06K 9/18; G06K 9/6215; G06K 9/6218; G06K 9/52; G06T 7/60; G06Q 30/0631; G06F 17/30598; G06F 17/214; G06F 17/30867

(57) ABSTRACT

A system includes a computing device that includes a memory configured to store instructions. The system also includes a processor to execute the instructions to perform operations that include receiving data representing a plurality of fonts, each font being different. For each pair of different fonts, operations include determining a level of similarity from a metric calculated for each font included in the pair, the metric being calculated from the received data and representing one or more font attributes. Operations also include grouping the fonts of the plurality of fonts based on the determined levels of similarities. Operations also include identifying individuals having an affinity towards one or more fonts included in the font groups. Operations also include grouping the identified individuals based on the affinity, and, presenting information to one or more of the identified individuals based on the grouping of the individuals.

### BACKGROUND

This description relates to using similarities of fonts to form groups of similar fonts. Along with grouping fonts, end users may be grouped in a similar manner for presenting potential fonts of interest to group members.

Proportional to the astronomical growth of available text content, for example via the Internet, the demand to express such content has grown. Similar to the variety of products provided by online stores; content authors, publishers, graphic designers, etc. have grown accustomed to having a vast variety of fonts to present text. However, this virtual explosion in the sheer number of usable fonts can become overwhelming and saturate an individual attempting to find and select a font to present content. Faced with such an overabundance of information, decision-making abilities can be hampered causing the individual to become frustrated.

### SUMMARY

The systems and techniques described can aid individuals such as designers (e.g., website designers) in efficiently finding and selecting fonts that may resonant with the person. By gathering and processing data associated with various fonts, similarities among the fonts may be detected and used to form groups of common fonts. The individual fonts included in a group can then be presented to an individual user/customer (e.g., a potential font purchaser) known to be interested in the attributes shared among font group members. By grouping fonts based upon their similarities, the individual can quickly jump between groups of similar fonts and, with minimal delay, select fonts (e.g., for purchase). Further, individuals may be grouped based upon their interest in particular fonts, font attributes, etc. to assist the process in efficiently presenting potential fonts of interest for selection by the individual. Similar to font groups, other types of information may presented to the individuals based on their determined interests. Other types of graphics (e.g., images), equipment and their capabilities (e.g. display device) along with other products and/or services may be identified and presented to individuals (e.g., potential purchasers).

In one aspect, a computing device implemented method includes receiving data representing a plurality of fonts, each font being different. For each pair of different fonts, a level of similarity is determined from a metric calculated for each font included in the pair. The metric being calculated from the received data and representing one or more font attributes. The method also includes grouping the fonts of the plurality of fonts based on the determined levels of similarities. The method also includes identifying individuals having an affinity towards one or more fonts included in the font groups. The method also includes grouping the identified individuals based on the affinity, and, presenting information to one or more of the identified individuals based on the grouping of the individuals.

Implementations may include one or more of the following features. The received data may be solicited or unsolicited from users. The received data may be weighted based upon one or more font attributes represented by the data. A portion of the received data may be adjusted to identify commonality with another portion of the received data. The grouping the fonts may utilize a clustering algorithm. The metric for a font may be a vector of numerical elements and each numerical element represents an attribute of the font. The level of similarity between two fonts may be determined by calculating the distance between the metrics of the two fonts. Presenting information to one or more of the identified individuals may include providing font selection recommendations to the group individuals. Presenting information to one or more of the identified individuals may include providing related product or service recommendations to the group individuals. The method may further include repeating the level of similarity determinations to update the font groups. The method may further include repeating the identifying of individuals to update the groups of individuals.

In another aspect, a system includes a computing device that includes a memory configured to store instructions. The system also includes a processor to execute the instructions to perform operations that include receiving data representing a plurality of fonts, each font being different. For each pair of different fonts, a level of similarity is determined from a metric calculated for each font included in the pair. The metric being calculated from the received data and representing one or more font attributes. Operations also include grouping the fonts of the plurality of fonts based on the determined levels of similarities. Operations also include identifying individuals having an affinity towards one or more fonts included in the font groups. Operations also include grouping the identified individuals based on the affinity, and, presenting information to one or more of the identified individuals based on the grouping of the individuals.

Implementations may include one or more of the following features. The received data may be solicited or unsolicited from users. The received data may be weighted based upon one or more font attributes represented by the data. A portion of the received data may be adjusted to identify commonality with another portion of the received data. The grouping the fonts may utilize a clustering algorithm. The metric for a font may be a vector of numerical elements and each numerical element represents an attribute of the font. The level of similarity between two fonts may be determined by calculating the distance between the metrics of the two fonts. Presenting information to one or more of the identified individuals may include providing font selection recommendations to the group individuals. Presenting information to one or more of the identified individuals may include providing related product or service recommendations to the group individuals. Operations may further include repeating the level of similarity determinations to update the font groups. Operations may further include repeating the identifying of individuals to update the groups of individuals.

In another aspect, one or more computer readable media storing instructions that are executable by a processing device, and upon such execution cause the processing device to perform operations that include receiving data representing a plurality of fonts, each font being different. For each pair of different fonts, a level of similarity is determined from a metric calculated for each font included in the pair. The metric being calculated from the received data and representing one or more font attributes. Operations also include grouping the fonts of the plurality of fonts based on the determined levels of similarities. Operations also include identifying individuals having an affinity towards one or more fonts included in the font groups. Operations also include grouping the identified individuals based on the affinity, and, presenting information to one or more of the identified individuals based on the grouping of the individuals.

Implementations may include one or more of the following features. The received data may be solicited or unsolicited from users. The received data may be weighted based upon one or more font attributes represented by the data. A portion of the received data may be adjusted to identify commonality with another portion of the received data. The grouping the fonts may utilize a clustering algorithm. The metric for a font may be a vector of numerical elements and each numerical element represents an attribute of the font. The level of similarity between two fonts may be determined by calculating the distance between the metrics of the two fonts. Presenting information to one or more of the identified individuals may include providing font selection recommendations to the group individuals. Presenting information to one or more of the identified individuals may include providing related product or service recommendations to the group individuals. Operations may further include repeating the level of similarity determinations to update the font groups. Operations may further include repeating the identifying of individuals to update the groups of individuals.

These and other aspects, features, and various combinations may be expressed as methods, apparatus, systems, means for performing functions, program products, etc.

Other features and advantages will be apparent from the description and the claims.

### DESCRIPTION OF DRAWINGS

FIG. 1 illustrates a smartphone presenting textual content in a font.

FIG. 2 illustrates similar fonts being presented on a computer display.

FIG. 3 is a block diagram of a network environment including a font service provider that manages font similarity information.

FIG. 4 is a block diagram of a font service provider.

FIG. 5 is a graphical representation of a groups of individuals being associated with groups of similar fonts.

FIG. 6 is a graphical representation of groups of individuals being associated with a group of similar fonts and a group of similar products.

FIG. 7 is a flowchart of operations for associating similar font groups and groups of similar individuals.

FIG. 8 illustrates an example of a computing device and a mobile computing device that can be used to implement the techniques described here.

### DETAILED DESCRIPTION

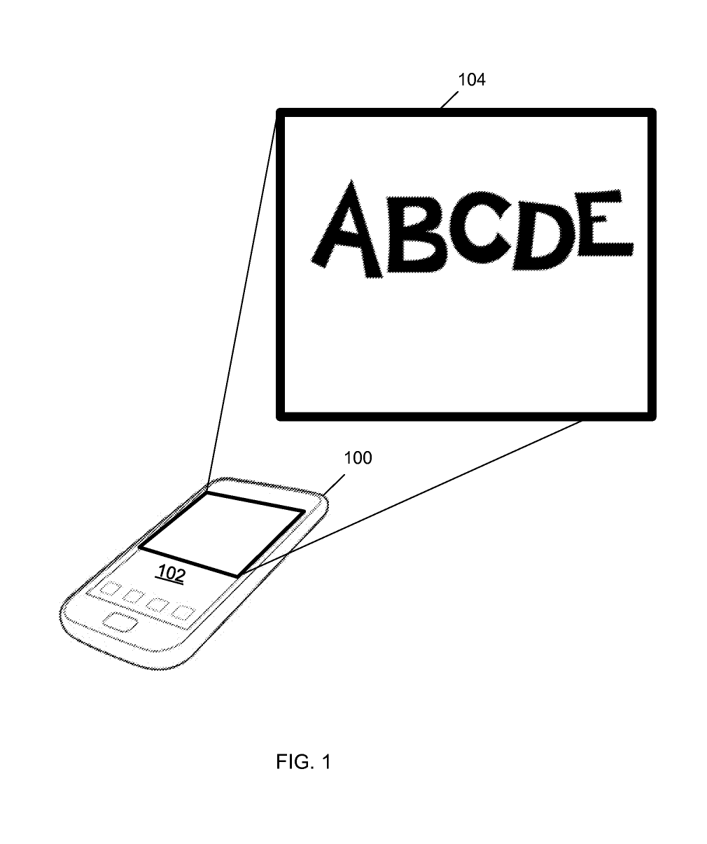

Referring to FIG. 1 a computing device (e.g., a mobile smartphone 100) includes a display 102 that allows user to view (and in some cases create, edit, etc.) various types of content such as text, via one more applications. Along with presenting different content from a variety of sources (e.g., Internet sites), browsers and other types of applications (e.g., word processors) may use different types of fonts to present a desired effect. For example, web assets (e.g., web pages, web sites, web based advertisements, etc.) may be developed that use particular fonts to quickly catch the attention of a viewer. With an ever-increasing number of fonts at a user's disposal (e.g., for web asset development, adjusting presented text, etc.), selecting an appropriate font for the project at hand could turn into be a noticeably time-consuming task. To reduce such a potential time sink, one or more techniques may be implemented to present available fonts (e.g., for purchase, license, etc.) to a user. By presenting fonts that have similar attributes, one or more fonts of a particular style may be identified and selected that resonate with the individual performing the selection. In the illustrated example, a portion 104 of the display 102 presents a string of capital characters (i.e., “A B C D E”) in a font that has attributes that could be considered as emotionally uplifting and project a positive connotation. Just as this font may suggest favorable feelings, other types of fonts may induce other feelings such as a negative, neutral or other type of emotion. To present the displayed text, the designer may have consciously selected this font to invoke such an emotion from the viewer. Selecting a font to achieve such an end result could take a considerable amount of time based on the number of potential candidates (e.g., hundreds, thousands, etc.). By quickly providing a selection of fonts within this particular genre (e.g., fonts that project an uplifting emotion), the designer might be able to compare such similar fonts and make a quick determination which font best suits the development effort. Additionally, by presenting such a collection of similar fonts to the designer, there may be an increase in the likelihood that the designer may license, etc. more fonts (within this genre) than originally planned, thereby potentially assisting the designer with other portions of this development and/or other developments (e.g., hardcopy print projects, etc.) and increase sales for a font provider.

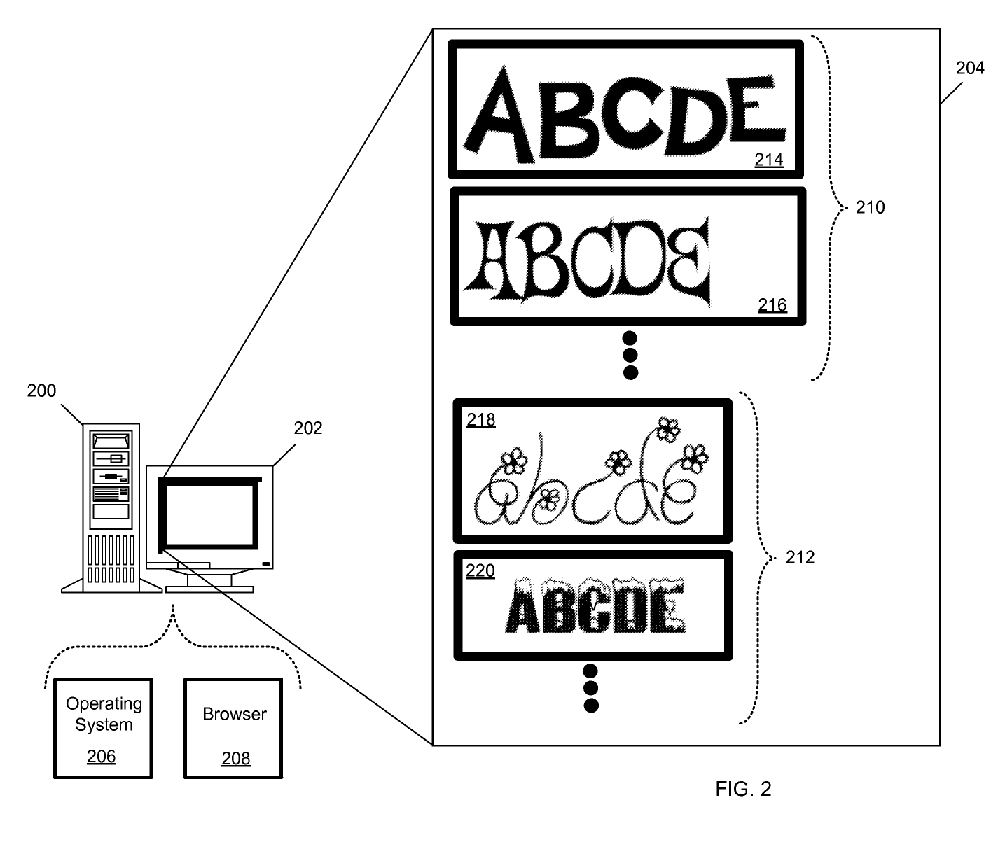

Referring to FIG. 2, a computer system 200 used for asset development is shown that includes a display 202 presenting a menu 204 that includes collections of selectable fonts, and each collection shares a common attribute. To present this information, the computer system 200 includes an operating system 206 and executes a browser that exchanges information with a variety of data sources (e.g., the one or more sources that provide the presented font collections). In this example, two selectable collections are presented to the viewer of the computer system, and the initial five English letters are used to display the different fonts. One collection 210 includes selectable fonts that convey a positive connotation and includes the font presented by the smartphone 100 in FIG. 1 (i.e., font 214). Another font 216 is also presented within the collection of positive fonts 210. Additional fonts are also included but are not displayed for ease of viewing. By presenting such fonts that may all induce a positive feelings, the viewer (e.g., a web page designer) can visually compare and contrast the fonts to determine which most appropriately fulfills his or her needs. The viewer may also determine that additional fonts may be desirable and multiple fonts may be selected (e.g., both fonts 214 and 216) for use on this project or other projects.

In this example, the fonts included the second collection 212 also share a common attribute; in this case each includes visual features associated with the different annual seasons. In particular, the characters of the font 218 have free flowing shapes and include a graphic of a flower to remind the viewer of spring. The winter season is visually suggested by the stark cold block lettering and the snow-like graphic covering each letter of the font 220. By presenting these fonts together (along with other fonts that reflect the seasons not shown), the viewer can select which font or fonts might be desired for project development.

To form groups of similar fonts one or more techniques may be employed. For example, one or more attributes of each font may be quantified to allow font comparison and identifying similarities. In general, a font attribute can be considered a characteristic (e.g., visual feature common to each character, character segment, etc.) or something else that forms an association with the font (e.g., font characters associated with a season, a period of time, etc.). Various techniques may be used to identify such attributes. For example, characteristics of a font character, character segment, etc. can be quantified by one or more processes executed by a computing device. Features of a character such as segment curviness, straightness, size, color, etc. may be quantified to produce a metric for the font. Other aspects of a font such as associations with genres (e.g., seasons, periods of time, the appearance of being handwritten, etc.) may quantified to determine similarities with other fonts. By quantifying multiple attributes, a vector may be used to represent the font that include values that represent different aspects of the font.

Data representing font attributes may be determined from various types of sources; for example, data from individuals (e.g., users, developers, etc.) may be collected and quantified. In some arrangements, such data may be collected in a solicited or unsolicited manner. For examples of solicited data; questionnaires, surveys, etc. may be presented to such individuals (e.g., via a webpage, website, etc.) for data collection. Such questions may ask the viewer to describe one or more fonts, for example, by providing comments about the font, selecting from a list of predefined categories (e.g., “the seasons”, “the 1920's”, etc.). In one arrangement, viewers may vote to provide categorical information (e.g., “Does this font remind you of fall [Y/N]”, “Does this font remind you of the 1920's [Y/N]”, etc.). To collect such data in an unsolicited manner, various techniques may be employed. For example, data representing user interactions with various fonts may be used for characterizing fonts. Instances in which a viewer interacts with font such as by selecting the font to gather information about the font, purchase the font, etc. can be used as a data source (e.g., using a pointing device to “click” on a graphical representation of the font, placing the font in an electronic album, electronic shopping chart, etc.). Somewhat more subtle interactions may also be used for data collection; for example, interest in one or more fonts (e.g., any of the representations present in the menu 204) may be gleamed from a pointing device being used to simply hover over a graphical representation of the respective font for a period of time (e.g., a second or more). Interactions may also include transactional information; for example, tracking purchases, licensing/subscriptions, etc. of different fonts.

Upon collecting such data from one or more sources, the data can be used to identify attributes that can be used to categorize the fonts and quantify similarities. As can be imagined, a limitless number of different categories can be associated with a font (e.g., the font reminds viewers of one or more seasons, appears to be handwritten, produces a positive emotion, etc.). In some arrangements the categories may be predefined and the collected data is used to determine how many categories are associated with a font, how strong is the association between a font and a category, etc. The collected data may also be used in define categories, for example, if viewers frequently provided input (e.g., entered comments) about a font (e.g., “the font reminds me of winter”), one or more attributes (e.g., winter, seasons, etc.) may be defined and associated to the font. Such provided comments may be similar and even match or align; for example, one user comment may mention that a font reminds them of the “1920's” while a shorthand version of the same sentiment is provided by another viewer (e.g., the font reminds me of the “20's”). For such situations, the provided comments may be processed to assist the identifying of the common attribute. For example, a viewer statement may be truncated to identify the particular root (e.g., decade) to which that font is associated. Using this example, a statement “font reminds me of the ‘1920's” may be processed to reduce the characterization to an attribute labeled as “20's”. To provide such a capability, one or more processes may be executed that filter words, phrases, etc. down to corresponding root terms. Such a processing technique can be considered as normalizing the viewer-provided descriptions to common attributes. By performing such normalizing, other processes can be assisted; for example, counting the number of instances that an attribute is provided by a viewer can be improved by first identifying that different descriptions are associated with the same attribute. Like determining roots of user-provided descriptions, other normalization techniques may be employed individually or in concert. For example, some viewer provided descriptions may not share common language but still be associated with a common attribute. For these instances, one or more rules may be used such that certain viewer-provided descriptions (e.g., provided terms such as “cheerful”, “joyful”, “lighthearted”, etc.) are considered as being equivalent to a predefined term (e.g., “happy”) and share a similar meaning By using one term to represent many, similar perceptions of viewers can be equated along with potentially reducing the number of attributes being used to characterize the font. Additionally once the provided descriptions are normalized, processes such as counting the instances that an attribute is used to describe a font can be efficiently executed.

Along to normalizing font descriptions provided by viewers, other types of processes may be executed to identify and assign an attribute to a font. For example, weights may be applied to one or more attributes of font; for example, to adjust attribute values based on importance. For demonstration, two attributes may be used for describing fonts; the first representing if a viewer considers the font as having handwritten characteristics and the second representing if the viewer considers the font as being associated with a season (e.g., the fall). In one example, the appearance of being handwritten may be considered more important than whether the font is associated with a season. As such, a larger weight may be applied to the quantity representing the “font appearing handwritten” attribute (e.g., a vote count from users) while a lesser (or no weight) is applied to the attribute of the font being associated with a season.

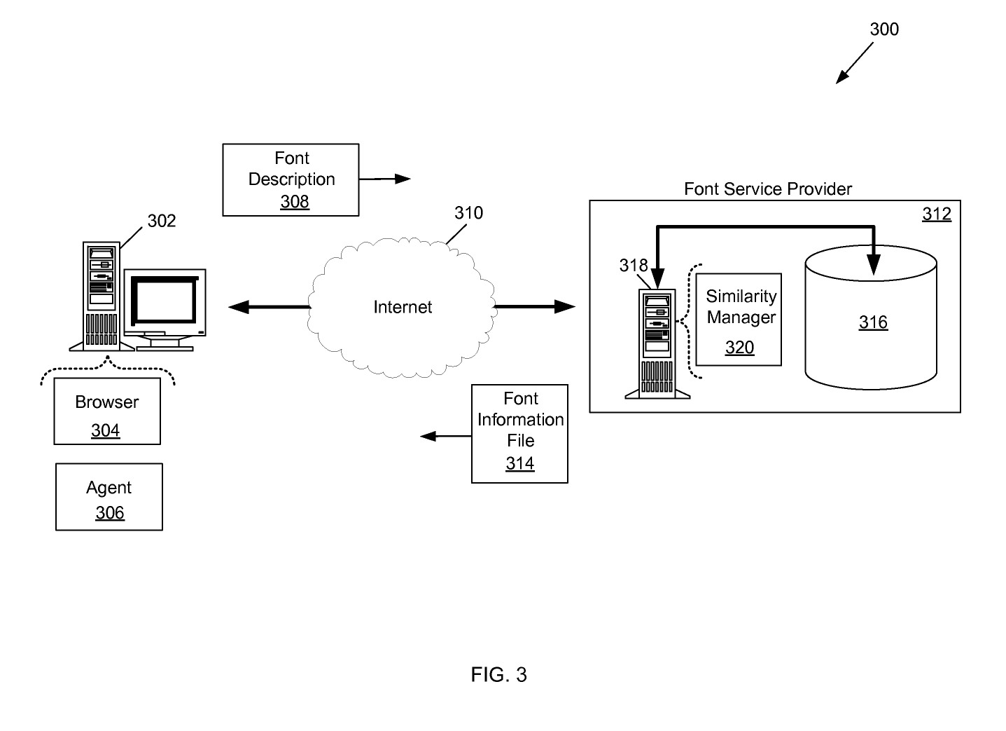

Referring to FIG. 3, a computing environment 300 is presented that includes a computer system 302 that a user may interact with (using a keyboard, a pointing device, etc.) for gathering information about fonts, font attributes, etc. In this arrangement, a browser application 304 provides an interface for collecting information from the user, however, other types of applications and processes may be employed. For example, the computer system 302 may execute a software agent 306 that collects information associated with font users, fonts, font attributes, etc. to determine similarities. In some arrangements the software agent 306 may solicit information from a user (e.g., request font descriptions, initiate surveys, etc.), or collect information in an unsolicited manner (e.g., collect pointing device movements, click data, etc.). Such agents may also monitor user interactions for determining user similarities (e.g., for grouping users). Such agents can be considered a software module that is executable in a substantially autonomous manner. For example, upon being provided access to the computer system 302, a software agent may operate without considerable user interaction. By operating in a somewhat flexible manner, the software agent can adaptively address font information needs. The software agent 306 may operate in a somewhat persistent manner to identify information associated with fonts, groups of fonts, etc. For example, the software agent 306 may execute in a substantially continuous manner.

In the presented environment 300, collected font description information 308 is sent over one or more networks (e.g., the Internet 310) to a font service provider 312 for processing (e.g., identifying font attributes, determining font similarity, grouping fonts, etc.). After the provided information is processed to identify similar fonts, one or more techniques may be implemented to provide the font similarity determinations to the computer system 302 or other computing devices. For example, one or more files, such as a font information file 314, may be produced by the font service provider 312 and sent to the computer system 302. In some arrangements, the font service provider 312 may also provide the software agents to the computing devices in order to perform operations, such as collecting font descriptions from users (e.g., via surveys, transaction data, click data, etc.), as needed. Agents delivered from the font service provider 312 may also provide other functions; for example, the agents may collect information to characterize the users and determine user similarities (e.g., font interests, etc.).

To process and store information associated with font similarities being provided by the computer system 302 (e.g., via the software agent 306), the font service provider 312 typically needs access to one or more libraries of fonts, font information, etc. that may be stored locally or remotely. For example, font libraries and libraries of font information may be stored in a storage device 316 (e.g., one or more hard drives, CD-ROMs, etc.) on site. Being accessible by a server 318, the libraries may be used, along with information provided from software agents, computing devices, etc., to collect needed information, determine similarities among fonts, provide the similarity information to end users (e.g., via the menu 104), etc. Illustrated as being stored in a single storage device 316, the font service provider 312 may also use numerous storage techniques and devices to retain collections of font information. Lists of fonts, fonts identified as being similar, one or more metrics of similarities, etc. can also be stored (e.g., on the storage device 316) for later retrieval and use. The font service provider 312 may also access font information at separate locations as needed. For example, along with identifying similar fonts for the computer system 302, the server 318 may be used to collect needed information from one or more sources external to the font service provider 312 (e.g., via the Internet 310).

Along with collecting, processing and providing font similarity information, the font service provider 312 may contribute other functions. For example, other types of information may be collected, processed, provided by the font service provider 312. In one arrangement, similarity information associated with individual users may be processed. By identifying similarities shared by individuals, the similarities could be used to direct particular font, groups of fonts, etc. to these individuals. For example, based upon information collected from a population of individuals, a subset of the individuals could be identified as sharing a common characteristic (e.g., each individual is a designer of wedding invitations). With knowledge of this information, fonts connected to this common interest (e.g., a font employing elegant features appropriate for a wedding invitation) can be identified, grouped and presented to each individual included in the group and sharing this characteristic. To provide such functionally, the server 318 executes a similarity manager 320, which, in general, determines similarities among fonts, individuals, etc. from collected information (provided to the font service provider 312). The font service manager 320 may also provide other functionality such as managing the data that represents similarities among the fonts, storage of the data for later retrieval, etc. As such, similarity information may be quickly identified and used for providing fonts or other type of information to a computing device (e.g., the computer system 302). In one arrangement, a database (or other technique for structuring and storing data) is stored at the font service provider 312 (e.g., on the storage device 316) and includes records that represent the similarities (or dissimilarities) among fonts, font group membership, etc. Such a database may be present for storing similarities of users and forming groups of similar users (e.g., for presenting fonts of potential interest to the group members). Similarly, the font service provider 312 may perform operations (e.g., tracking, monitoring, etc.) regarding other types of user information. For example, records may be stored that reflect particular fonts that have been requested, purchased, licensed, etc. and provided to a particular user, group, etc.

The environment 300 may utilize various types of architectures to provide this functionality. For example, by collecting font attribute information (e.g., via surveys, monitoring user interactions, etc.), the environment may employ one or more knowledge-based systems such as an expert system to determine font similarities. In general, such expert systems are designed solving relatively complex problems by using reasoning techniques that may employ conditional statements (e.g., if-then rules). In some arrangements such expert systems may use multiple systems such as a two sub-system design, in which one system component stores structured and/or unstructured information (e.g., a knowledge base) and a second system component applies rules, etc. to the stored information (e.g., an inference engine) to determine results of interest (e.g., font similarities).

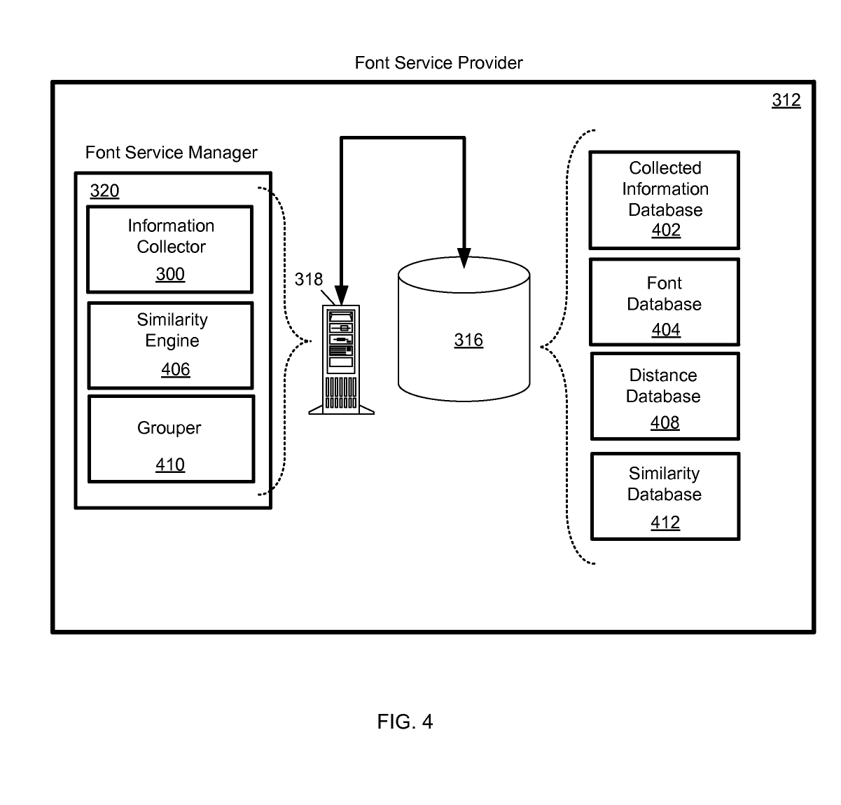

Referring to FIG. 4, the font service manager 320 (which includes a number of modules) is executed by the server 318 present at the font service provider 312. In this arrangement, the font service manager 320 includes an information collector 400 that is capable of receiving data that represents font descriptions (e.g., provided by users, developers, etc. via surveys, click data, etc.) and other types of data (e.g., information that characterizes users, survey-takers, etc.). In this arrangement, such data may be previously stored (e.g., surveys stored in a collected information database 402) and retrieved from the storage device 316. Data representing such survey information may also be retrieved from one or more sources external to the font service provider 312; for example such information may be attained from one or more storage devices of a survey manager (e.g., an entity separate from the font service provider 312). Along with survey information, the storage device 316 (or other storage devices at the font service provider 312) may contain a font database 404 that includes information about numerous fonts, previously determined font attributes, etc. From the information stored in the font database 404, data may be retrieved to produce surveys (e.g., sample font characters) for determining font similarity and other applications. For example, the font database 404 may include data that represents various types of font families (e.g., Times New Roman, Arial, etc.) that typically include a set of fonts (e.g., regular, italic, bold, bold italic, etc.). Data for each font may represent a set of individual character shapes (glyphs). Such glyphs generally share various design features (e.g., geometry, stroke thickness, serifs, size, etc.) associated with the font. To represent such fonts one or more techniques may be utilized; for example, outline-based representations may be adopted in which lines and curves are used to define the borders of glyphs. Along with different design features, fonts may differ based on functional aspects, such as the languages (e.g., English, Chinese, Russian, etc.) for which the fonts are used. Typically fonts are scalable for a variety of sizes (e.g., for presenting by various computing devices) and may be represented in one or more formats. For example, scalable outline fonts may be represented in a format that includes data structures capable of supporting a variety of typographic visual symbols of many languages.

In this example, a similarity engine 406 is included in the font service manager 320 and uses the collected information database 402 (e.g., survey data, click data, etc.) to determine similarity among fonts. Various techniques may be used by the similarity engine 406; for example, multiple attributes may be used to characterize a font and a numerical quantity may be assigned to each attribute to reflect the presence of each attribute in the font. For example, each attribute may be represented by an integer value that reflects a collected vote count (as determined from survey results, etc.). A font including graphical features that appear visually associated with winter may receive a substantial vote count for an attribute that characterizes the font as being associated with a season. Similarly, an integer may represent a vote count for an attribute associated with the font appearing handwritten, associated with a particular time period (e.g., the 1920's), etc. By having multiple vote counts represent the font, the values can be inserted into a vector. In some arrangements a large number of values (elements) can be included in a vector (e.g., tens of values) or a comparatively a smaller number elements (e.g., each representing a count value) may be included in a vector to represent a font.

In some arrangements, a vector representing attributes of a font may be processed prior to being used by the similarity engine to determine font similarities. For example, one or more weights may be applied to a portion of the elements of the vector. Weights may be applied to some count values to project the importance of an attribute (e.g., heavily weight vote count of the attribute representing that the font appears handwritten, lesser weighting of the vote count for the attribute representing the font being associated with a season). Beyond weighting the individual elements of a vector, an entire vector, etc., one or more other processing techniques may be applied to the vectors, vector elements, etc. individually or in concert to prepare the data for similarity determinations.

Once prepared, the similarity engine 406 can compare the vectors to determine similarly among the fonts. Various conventions may be used to define similarity; for example, amount of difference between the attributes of two fonts can be employed. This difference metric can be considered as the distance between the two fonts. As such, a pair of fonts that have a relatively small distance can be considered similar. Alternatively a font pair that has a large distance can be considered different. For one technique, the distance between two fonts is determined by calculating the difference between corresponding elements of the two vectors that represent the attributes of the fonts. Using this technique, the difference is determined between common elements in the vectors (e.g., the difference between the elements representing the vote count of the handwritten attribute for each of the two fonts). A single difference vector is produced from this computation that includes elements that represent the calculated differences. In some arrangements, the data of the difference vector may be further processed; for example, a single quantity can be calculated that represents the distance between the two fonts (e.g., sum the elements of the difference vector). Along with using the single quantity to represent the distance between the two fonts, this value may be stored for other analysis. For example, the single quantity, the difference vector, the vector for each corresponding font, etc. may be stored in a distance database 408 that resides in the storage device 316.

Such similarity computations can be executed for each different font pair stored in the font database 404 to produce a similarity measure (e.g., a difference vector, single similarity value, etc.). Once calculated and stored in the distance database 408, the data can be used processing the fonts (stored in the font database 404). Fonts identified as being similar may be grouped together in an automatic manner for various applications such as being presented together. For example, all similar fonts may be presented (on a computing device) to a viewer (e.g., a developer) to allow for visual comparison of these fonts (e.g., to detect subtle differences) and eventual selection (e.g., for use in a project, asset development, etc.). One or more techniques may be implemented for grouping fonts based upon the calculated distance information. For example, algorithms such as clustering algorithms may be employed. One grouping technique, referred to as k-means clustering algorithms, utilizes vector quantization to partition n observations into k clusters in which each observation belongs to the cluster with the nearest mean. One or more other clustering algorithms may be employed for grouping the fonts based on their similarity.

In one arrangement, one or multiple thresholds may be defined for determining if fonts should be grouped. Using one convention, if the calculated distance between two fonts is equivalent or below a predetermined threshold, the two fonts can be identified as similar and grouped together. If the distance between two fonts exceeds the threshold, the two fonts are not considered similar and are not grouped together. To provide this grouping functionality, a grouper 410 is included in the font service manager 320 being executed at the font service provider 312. In some instances, a font may appear in multiple groups (e.g., based upon the distance information); for example, a font may be a member of group associated with fonts that appear to be handwritten and the same font may also be a member of a group that includes fonts associate with the seasons (e.g., fonts that invoke memories of spring, fall, etc.). The grouper 410 may place restrictions on font grouping in some arrangements; for example, one or more rules may be employed in some situations to limit a font to only being a member of one group, a limited number of groups, etc. Upon creating groups of fonts based on the distance information, data reflecting the groups, group members, etc. is stored in a similarity database 412 that is also stored at the font service provider 312 for later retrieval and use (e.g., identifying group for presentation to a potential purchaser). Along with creating such groups, the grouper 410 may provide other functionality; for example, groups may be updated as new fonts are developed, additional information (e.g., new surveys) is received by the font service provider 312, etc. In one arrangement, a trigger signal may be sent to the grouper 410 for each occurrence that new information has been received at the collected information database 402. Current groups can then be checked for membership adjustments, new groups potentially formed, groups potentially disbanded (e.g., deleted), etc. upon of arrival of this new information. Performed in an automated manner, the grouper 410 can be considered as tuning the fonts, font groups, etc. Other events may also trigger the grouper 410 to execute operations to check and potentially adjust font groups. For example, adjustments to one or more instructions, rules, etc. used by the similarity engine 406 (e.g., change distance calculation process) may trigger a review of the groupings reflected in the similarity database 412. Changes to fonts represented in the font database 404 may also trigger a review of the font groups. For example, the introduction of one or more fonts, the deletion of a font (or multiple fonts), adjusting fonts, etc. can cause a trigger signal to be sent to processes such as the grouper 410, the similarity engine 406, etc. to initiate a review of the distance data stored in the database 408 and the font groups stored in the database 412. As such, various type of events may be defined to initiate tuning of the font groups and improve font presentations for potential purchasers.

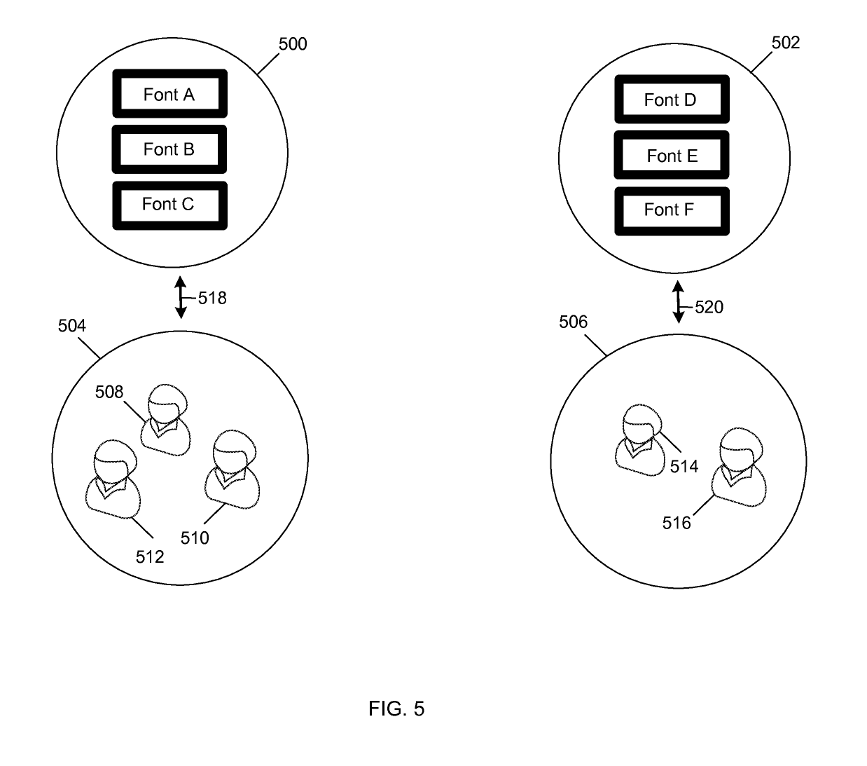

Referring to FIG. 5, along with determining similarities among different fonts, other types of information may be used to defined groups and form associations among groups of similar or different kinds. Data may be collected and processed to form groups having individuals as members. Once formed, characteristics of the groups may be used to form an association with other groups such as a font group. Through such a connection, individuals potentially interested in similar fonts could be groups together. Characteristics of the individuals, e.g., commonly shared among some or all of the group members, may be used to form associations with font groups. Further, by knowing the interests of the group, fonts could be presented to each group member to stimulate interest, use of particular fonts, commerce, etc. As illustrated in the figure, two groups of fonts 500 and 502 are graphically illustrated, and each group includes three individual fonts (e.g., group 500 includes fonts A, B, and C, and group 502 includes fonts D, E, and F). Similar to grouping the fonts based on their characteristics, individuals are grouped based upon similarities. In this example, one group 504 includes individuals 508, 510, and 512 while a second and separate group 506 includes two individuals 514 and 516. Based upon the shared characteristics of the individuals in these groups 505 and 506, an association can be detected with particular font groups. For example, the font group 500 can includes fonts having attributes associated with the calendar seasons and the members of the group may have a close affinity to this topic (e.g., each person enjoys using a font that reflects the current season). Similarly, the fonts of group 502 each share the attribute of appearing to be handwritten and the individuals 514, 516 of group 506 each share an affinity to using such fonts. As such an association is formed among these group pairs as graphically represented by arrows 518 and 520. Based upon these connections, operations may be executed, e.g., at the font service provider 312, to capitalize on these detected group associations. For example, each member of the font group 500 would be presented to each individual member of the group 504 (when the respective individual initiates a session to review and potentially select one or more fonts). Similarly, samples of each font included in group 502 would be presented to each member of group 506 when inspecting fonts provided by the font service provider 312. In some arrangements, the fonts may be presented to corresponding group members in an unsolicited manner; for example, when the operations of the font service manager 320 identify the association between a font group and a group of individuals, information (e.g., an electronic message) may be sent from the font service provider 312 to each individual (e.g., character samples of font A, B, and C are sent to each of the individuals 508, 510 and 512) to stimulate interest in the individual to review the fonts and potentially select one or more.

Similar to the information used to determine similarities in fonts, various type of information may be used to detect similarities among individuals. For example, information directly collected from individuals (e.g., surveys, questionnaires, etc.), unsolicited information, etc. individually or in concert may be employed. Directly collected information may ask the individuals about different fonts (e.g., “Do you like Font A”, “Do you like Font B”, etc.). Prior font related activities such as previous purchases, demonstrated interest (e.g., provided by click data, etc.), etc. may be collected from the individuals (e.g., via a software agent being executed by the individual's computing device). In some arrangements some information may be weighted heavier than other types of information. For example, the purchase history of an individual may be more heavily weighted than other types of user activity (e.g., click data that reflects just browsing different fonts). Information from user applications may also provide an information source into an individual's interest in various fonts, font attributes, etc. For example, a software agent executed by the individual's computing device may collect data that represents fonts frequently used by applications (e.g., word processors, web browsers, etc.) executed by the device.

Provided this information, the process of the font service management 320 may develop attributes of individuals (e.g., vectors quantities of various attributes). Using the similarity engine 406 (or one or more comparable processes) the font service manager 320 can develop distance measure between different individuals and store them for future use. A grouping process (e.g., similar to grouper 410) can identify groups and respectively assign individuals to corresponding groups, which can be stored (in a database) and managed (e.g., updated).

Similar to adjusting font groupings, groups of individuals may also be adjusted over time based on different situations such as the appearance of new information. For example, collected data may reflect that an individual's interest in fonts may change over time (and in some cases be the change may be cyclical). For instance, during the holiday season an individual may be more interested in fonts associated the season (e.g., festive and colorful fonts) than other times of the year (e.g., return to using a more classic and plain font during the rest of the year). By monitoring the information from the user that reflects these changes, the grouping of the individual may be adjusted on a temporal basis. For example, similarity calculations may be repeated at predefined intervals to adjust the grouping of individuals. Adjustments to groupings may also be event driven; for example, if the font purchasing pattern change for one or a few members of a group (e.g., as detected from solicited and/or unsolicited information collected from them), the font service manager 320 may recalculate similarity data for the individuals along with the grouping of the individuals. Direct feedback from individuals may also trigger a reassessment of similarities and groupings; for example, the type of project typically produced by a designer included in a group may change (e.g., the designer previously worked on magazines but now works on wedding invitations) which may propagate into different fonts of interest.

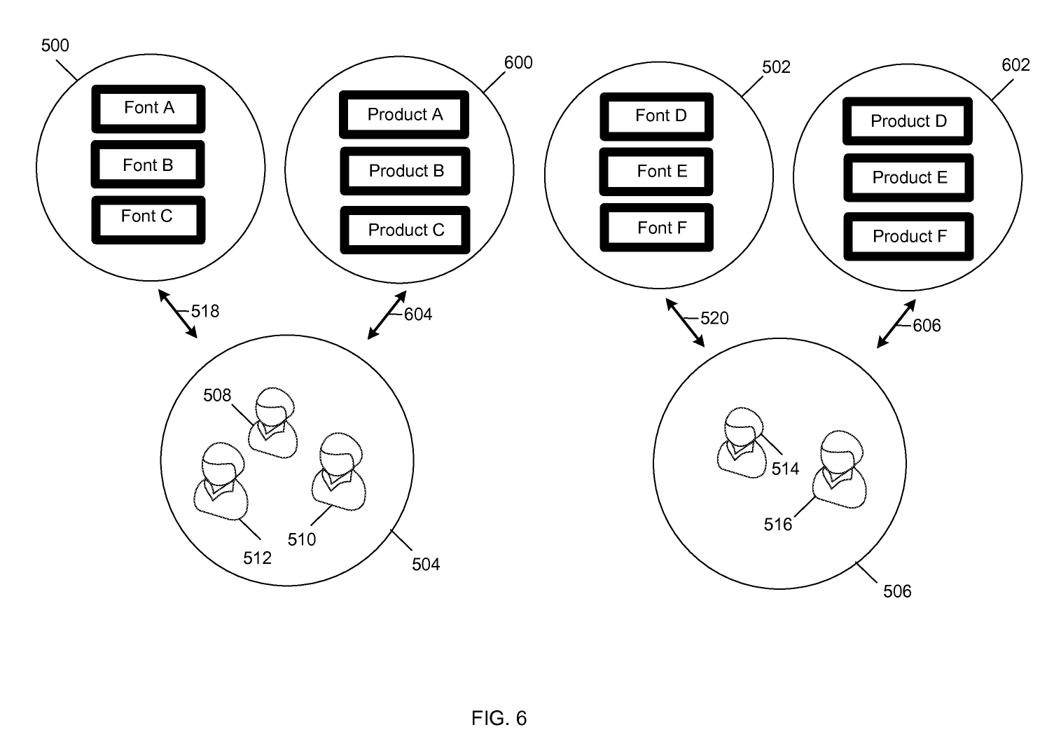

Referring to FIG. 6, similarities, grouping and forming associations can be extended beyond fonts and individuals. For example, products, services, interests, etc. can be connected to the associations formed between font and individual groups. In this illustration, services that are associated with particular fonts are joined to the font group and individual group associations. For example, some services such as identifying background colors, complementary images, lighting conditions etc. may assist with presenting certain fonts. As such, individuals interested in these fonts may also be interested in one or more of these services. As illustrated in the figure, a group of services 600 includes three individual services (e.g., Service A, Service B and Service C) that can be considered as assisting the presentation of the fonts in group 500 (e.g., selecting potential backgrounds, lighting conditions, etc. that complement the font group members). Similarly, a product group 602 includes three services (e.g., Service D, Service E and Service F) that can be considered more appropriate than others to assist the presenting the fonts of group 502. Based upon the previously defined association of the font group 500 and the group of individuals 504, another association is defined between the service group 600 and the group of individuals 504. Based upon the forming of this association, information may be provided (e.g., via the font service provider 312, another service, etc.). For example, electronic messages, text messages, targeted advertisements, etc. may be sent to the members of the group 504. In some arrangements, the information may point out the connection between the services of group 600 and the fonts of group 500, or, the connection between the groups may not be directly presented.

Similar to updating font groups and/or groups of individuals, groups of associated products, services, etc. may be adjusted as needed. For example, after a font group has been adjusted based upon changes in similarities, the products included in an associated product group may be updated to reflect the span of font membership (e.g., products may be added, removed, etc. from the list based upon the presentation needs). Such adjustments to the product group may be driven by particular events (e.g., adjustments to an associated font group, group of individuals, etc.), temporal considerations (e.g., font group and individual group changes), etc.

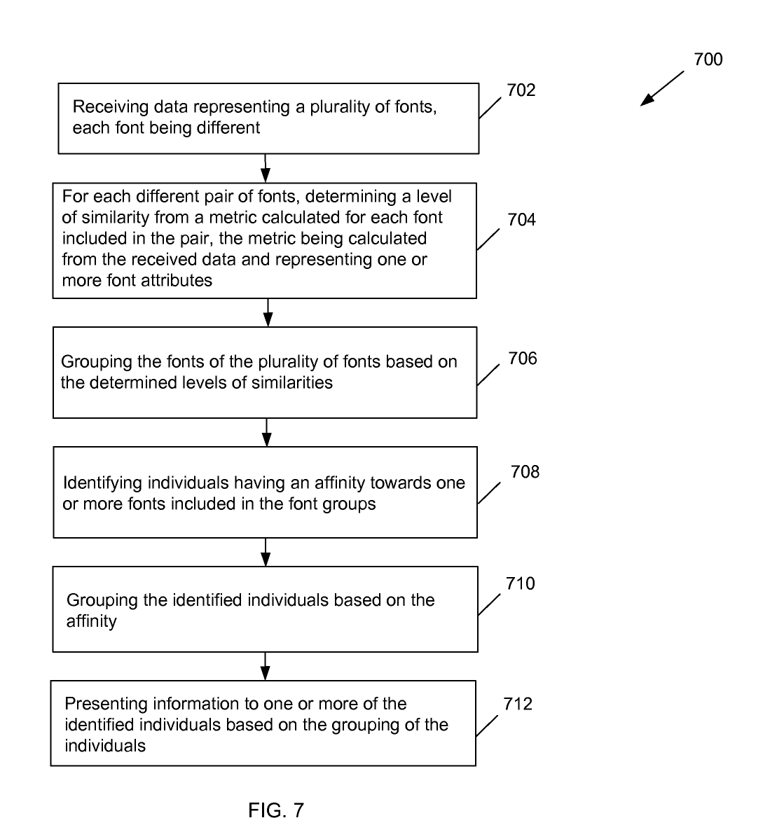

Referring to FIG. 7, a flowchart 700 represents operations of a font service manager (e.g., the font service manager 320 shown in FIG. 3) being executed by a computing device (e.g., the server 318 located at the font service provider 312). Operations of the font service manager 320 are typically executed by a single computing device (e.g., the server 318); however, operations may be executed by multiple computing devices. Along with being executed at a single site (e.g., the font service provider 312), the execution of operations may be distributed among two or more locations. In some arrangements, a portion of the operations may be executed at a user device (e.g., the computing device 302), an intermediate computing device (e.g., located between a user device and the font service provider), one or more computing devices located external to the font service provider 312, etc.

Operations of the font service manager 320 may include receiving 702 data representing a plurality of fonts, each font being different. For example, solicited user feedback (e.g., survey data), unsolicited user feedback (e.g., click data representing user interactions), etc. may be received by the font service manager 320. For each pair of different fonts, operations may include determining 704 a level of similarity from a metric calculated for each font included in the pair. The metric is calculated from the received data and the metric represents one or more font attributes. For example, a vector of elements may be produced in which each element represents one or more attributes of the font. Operations may also include grouping 706 the fonts of the plurality of fonts based on the determined levels of similarities. For example, by determining the distance between the fonts of the font pair (e.g., by comparing the vector quantities of the fonts), a similarity measure may be determined and used (e.g., via one or more threshold) to group similar fonts. Operations may also include identifying 708 individuals having an affinity towards one or more fonts included in the font groups. For example, based upon characteristics of the individuals (e.g., attained through survey feedback from the individuals, transaction history of the individuals, etc.), associations between individuals and fonts may be identified. Operations may also include grouping 710 the identified individuals based on the affinity. For example, individuals that are drawn to particular fonts, font styles, etc. may be grouped. In some arrangements, a vector quantity may be used to represent the characteristics of a corresponding individual. These vector quantities may be compared to determine similar among the individuals (e.g., calculate the distance between each pair of vector quantities). Operations may also include presenting 712 information to one or more of the identified individuals based on grouping the individuals. For example, samples of fonts (e.g., sample characters of a font) may be provided to each individual included in a group that is considered to be possibly interested in the fonts (e.g., to efficiently alert the individuals to the fonts and possibly stimulate the individuals into purchasing, licensing, etc. the fonts).

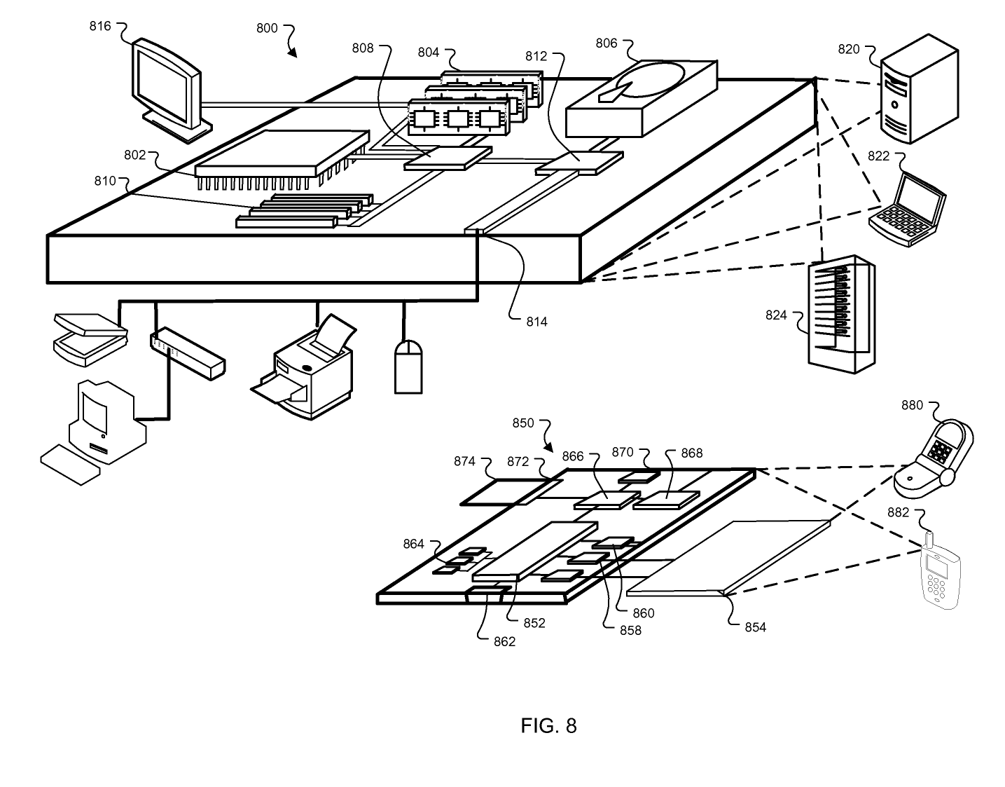

FIG. 8 shows an example of example computing device 800 and example mobile computing device 850, which can be used to implement the techniques described herein. For example, a portion or all of the operations of text layout engine 200 (shown in FIG. 2) may be executed by the computing device 800 and/or the mobile computing device 850. Computing device 800 is intended to represent various forms of digital computers, including, e.g., laptops, desktops, workstations, personal digital assistants, servers, blade servers, mainframes, and other appropriate computers. Computing device 850 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 800 includes processor 802, memory 804, storage device 806, high-speed interface 808 connecting to memory 804 and high-speed expansion ports 810, and low speed interface 812 connecting to low speed bus 814 and storage device 806. Each of components 802, 804, 806, 808, 810, and 812, are interconnected using various busses, and can be mounted on a common motherboard or in other manners as appropriate. Processor 802 can process instructions for execution within computing device 800, including instructions stored in memory 804 or on storage device 806 to display graphical data for a GUI on an external input/output device, including, e.g., display 816 coupled to high speed interface 808. In other implementations, multiple processors and/or multiple busses can be used, as appropriate, along with multiple memories and types of memory. Also, multiple computing devices 800 can be connected, with each device providing portions of the necessary operations (e.g., as a server bank, a group of blade servers, or a multi-processor system).

Memory 804 stores data within computing device 800. In one implementation, memory 1204 is a volatile memory unit or units. In another implementation, memory 804 is a non-volatile memory unit or units. Memory 804 also can be another form of computer-readable medium (e.g., a magnetic or optical disk. Memory 804 may be non-transitory.)

Storage device 806 is capable of providing mass storage for computing device 800. In one implementation, storage device 806 can be or contain a computer-readable medium (e.g., a floppy disk device, a hard disk device, an optical disk device, or a tape device, a flash memory or other similar solid state memory device, or an array of devices, such as devices in a storage area network or other configurations.) A computer program product can be tangibly embodied in a data carrier. The computer program product also can contain instructions that, when executed, perform one or more methods (e.g., those described above.) The data carrier is a computer- or machine-readable medium, (e.g., memory 804, storage device 806, memory on processor 802, and the like.)

High-speed controller 808 manages bandwidth-intensive operations for computing device 1300, while low speed controller 812 manages lower bandwidth-intensive operations. Such allocation of functions is an example only. In one implementation, high-speed controller 808 is coupled to memory 804, display 816 (e.g., through a graphics processor or accelerator), and to high-speed expansion ports 810, which can accept various expansion cards (not shown). In the implementation, low-speed controller 812 is coupled to storage device 806 and low-speed expansion port 814. The low-speed expansion port, which can include various communication ports (e.g., USB, Bluetooth®, Ethernet, wireless Ethernet), can be coupled to one or more input/output devices, (e.g., a keyboard, a pointing device, a scanner, or a networking device including a switch or router, e.g., through a network adapter.)

Computing device 800 can be implemented in a number of different forms, as shown in the figure. For example, it can be implemented as standard server 820, or multiple times in a group of such servers. It also can be implemented as part of rack server system 824. In addition or as an alternative, it can be implemented in a personal computer (e.g., laptop computer 822.) In some examples, components from computing device 800 can be combined with other components in a mobile device (not shown), e.g., device 850. Each of such devices can contain one or more of computing device 800, 850, and an entire system can be made up of multiple computing devices 800, 850 communicating with each other.

Computing device 850 includes processor 852, memory 864, an input/output device (e.g., display 854, communication interface 866, and transceiver 868) among other components. Device 850 also can be provided with a storage device, (e.g., a microdrive or other device) to provide additional storage. Each of components 850, 852, 864, 854, 866, and 868, are interconnected using various buses, and several of the components can be mounted on a common motherboard or in other manners as appropriate.

Processor 852 can execute instructions within computing device 850, including instructions stored in memory 864. The processor can be implemented as a chipset of chips that include separate and multiple analog and digital processors. The processor can provide, for example, for coordination of the other components of device 850, e.g., control of user interfaces, applications run by device 850, and wireless communication by device 850.

Processor 852 can communicate with a user through control interface 858 and display interface 856 coupled to display 854. Display 854 can be, for example, a TFT LCD (Thin-Film-Transistor Liquid Crystal Display) or an OLED (Organic Light Emitting Diode) display, or other appropriate display technology. Display interface 856 can comprise appropriate circuitry for driving display 854 to present graphical and other data to a user. Control interface 858 can receive commands from a user and convert them for submission to processor 852. In addition, external interface 862 can communicate with processor 842, so as to enable near area communication of device 850 with other devices. External interface 862 can provide, for example, for wired communication in some implementations, or for wireless communication in other implementations, and multiple interfaces also can be used.

Memory 864 stores data within computing device 850. Memory 864 can be implemented as one or more of a computer-readable medium or media, a volatile memory unit or units, or a non-volatile memory unit or units. Expansion memory 874 also can be provided and connected to device 850 through expansion interface 872, which can include, for example, a SIMM (Single In Line Memory Module) card interface. Such expansion memory 874 can provide extra storage space for device 850, or also can store applications or other data for device 850. Specifically, expansion memory 874 can include instructions to carry out or supplement the processes described above, and can include secure data also. Thus, for example, expansion memory 874 can be provided as a security module for device 850, and can be programmed with instructions that permit secure use of device 850. In addition, secure applications can be provided through the SIMM cards, along with additional data, (e.g., placing identifying data on the SIMM card in a non-hackable manner.)

The memory can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer- or machine-readable medium (e.g., memory 864, expansion memory 874, and/or memory on processor 852), which can be received, for example, over transceiver 868 or external interface 862.

Device 850 can communicate wirelessly through communication interface 866, which can include digital signal processing circuitry where necessary. Communication interface 866 can provide for communications under various modes or protocols (e.g., GSM voice calls, SMS, EMS, or MMS messaging, CDMA, TDMA, PDC, WCDMA, CDMA2000, or GPRS, among others.) Such communication can occur, for example, through radio-frequency transceiver 868. In addition, short-range communication can occur, e.g., using a Bluetooth®, WiFi, or other such transceiver (not shown). In addition, GPS (Global Positioning System) receiver module 870 can provide additional navigation- and location-related wireless data to device 850, which can be used as appropriate by applications running on device 850. Sensors and modules such as cameras, microphones, compasses, accelerators (for orientation sensing), etc. may be included in the device.

Device 850 also can communicate audibly using audio codec 860, which can receive spoken data from a user and convert it to usable digital data. Audio codec 860 can likewise generate audible sound for a user, (e.g., through a speaker in a handset of device 850.) Such sound can include sound from voice telephone calls, can include recorded sound (e.g., voice messages, music files, and the like) and also can include sound generated by applications operating on device 850.

Computing device 850 can be implemented in a number of different forms, as shown in the figure. For example, it can be implemented as cellular telephone 880. It also can be implemented as part of smartphone 882, a personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A computing device implemented method comprising:
receiving data representing a plurality of fonts, each font being different;
for each pair of different fonts, determining a level of similarity from a metric calculated for each font included in the pair, the metric being calculated from the received data and representing one or more font attributes;
grouping the fonts of the plurality of fonts based on the determined levels of similarities;
identifying individuals having an affinity towards one or more fonts included in the font groups;
grouping the identified individuals based on the affinity; and
presenting information to one or more of the identified individuals based on the grouping of the individuals.

2. The computing device implemented method of claim 1, wherein the received data is solicited from users.

3. The computing device implemented method of claim 1, wherein the received data is unsolicited from users.

4. The computing device implemented method of claim 1, wherein in the received data is weighted based upon one or more font attributes represented by the data.

5. The computing device implemented method of claim 1, wherein a portion of the received data is adjusted to identify commonality with another portion of the received data.

6. The computing device implemented method of claim 1, wherein the grouping the fonts utilizes a clustering algorithm.

7. The computing device implemented method of claim 1, wherein the metric for a font is a vector of numerical elements and each numerical element represents an attribute of the font.

8. The computing device implemented method of claim 1, wherein the level of similarity between two fonts is determined by calculating the distance between the metrics of the two fonts.

9. The computing device implemented method of claim 1, wherein presenting information to one or more of the identified individuals includes providing font selection recommendations to the group individuals.

10. The computing device implemented method of claim 1, wherein presenting information to one or more of the identified individuals includes providing related product or service recommendations to the group individuals.

11. The computing device implemented method of claim 1, further comprising:
repeating the level of similarity determinations to update the font groups.

12. The computing device implemented method of claim 1, further comprising:
repeating the identifying of individuals to update the groups of individuals.

13. A system comprising:
a computing device comprising:
a memory configured to store instructions; and
a processor to execute the instructions to perform operations comprising:
receiving data representing a plurality of fonts, each font being different;
for each pair of different fonts, determining a level of similarity from a metric calculated for each font included in the pair, the metric being calculated from the received data and representing one or more font attributes;
grouping the fonts of the plurality of fonts based on the determined levels of similarities;
identifying individuals having an affinity towards one or more fonts included in the font groups;
grouping the identified individuals based on the affinity; and
presenting information to one or more of the identified individuals based on the grouping of the individuals.

14. The system of claim 13, wherein the received data is solicited from users.

15. The system of claim 13, wherein the received data is unsolicited from users.

16. The system of claim 13, wherein in the received data is weighted based upon one or more font attributes represented by the data.

17. The system of claim 13, wherein a portion of the received data is adjusted to identify commonality with another portion of the received data.

18. The system of claim 13, wherein the grouping the fonts utilizes a clustering algorithm.

19. The system of claim 13, wherein the metric for a font is a vector of numerical elements and each numerical element represents an attribute of the font.

20. The system of claim 13, wherein the level of similarity between two fonts is determined by calculating the distance between the metrics of the two fonts.

21. The system of claim 13, wherein presenting information to one or more of the identified individuals includes providing font selection recommendations to the group individuals.

22. The system of claim 13, wherein presenting information to one or more of the identified individuals includes providing related product or service recommendations to the group individuals.

23. The system of claim 13, the operations further comprising:
repeating the level of similarity determinations to update the font groups.

24. The system of claim 13, the operations further comprising:
repeating the identifying of individuals to update the groups of individuals.

25. One or more computer readable media storing instructions that are executable by a processing device, and upon such execution cause the processing device to perform operations comprising:
receiving data representing a plurality of fonts, each font being different;
for each pair of different fonts, determining a level of similarity from a metric calculated for each font included in the pair, the metric being calculated from the received data and representing one or more font attributes;
grouping the fonts of the plurality of fonts based on the determined levels of similarities;
identifying individuals having an affinity towards one or more fonts included in the font groups;
grouping the identified individuals based on the affinity; and
presenting information to one or more of the identified individuals based on the grouping of the individuals.

26. The computer readable media of claim 25, wherein the received data is solicited from users.

27. The computer readable media of claim 25, wherein the received data is unsolicited from users.

28. The computer readable media of claim 25, wherein in the received data is weighted based upon one or more font attributes represented by the data.

29. The computer readable media of claim 25, wherein a portion of the received data is adjusted to identify commonality with another portion of the received data.

30. The computer readable media of claim 25, wherein the grouping the fonts utilizes a clustering algorithm.

31. The computer readable media of claim 25, wherein the metric for a font is a vector of numerical elements and each numerical element represents an attribute of the font.

32. The computer readable media of claim 25, wherein the level of similarity between two fonts is determined by calculating the distance between the metrics of the two fonts.

33. The computer readable media of claim 25, wherein presenting information to one or more of the identified individuals includes providing font selection recommendations to the group individuals.

34. The computer readable media of claim 25, wherein presenting information to one or more of the identified individuals includes providing related product or service recommendations to the group individuals.

35. The computer readable media of claim 25, the operations further comprising:
repeating the level of similarity determinations to update the font groups.

36. The computer readable media of claim 25, the operations further comprising:
repeating the identifying of individuals to update the groups of individuals.
